(19) United States
(12) Patent Application Publication
(10) Pub. No.: US 2008/0071078 A1
(43) Pub. Date: Mar. 20, 2008

(54) METHOD OF MAKING CELLULOSE ESTER POLYMER AND PRE-TREATING CELLULOSE FOR THE MANUFACTURE OF CELLULOSE ESTER POLYMER

(76) Inventors: Lawton E. Kizer, Blacksburg, VA (US); Frederick C. Samz, Blacksburg, VA (US); Henry P. Stogner, Bluefield, WV (US); Charles E. Toney, Christiansburg, VA (US); Linfu Wang, Blacksburg, VA (US)

Correspondence Address: HAMMER & HANF, PC, 3125 SPRINGBANK LANE, SUITE G, CHARLOTTE, NC, 28226, US

(21) Appl. No.: 11/566,250

(22) Filed: Dec. 4, 2006

Related U.S. Application Data
(60) Provisional application No. 60/845,664, filed on Sep. 19, 2006.

(51) Int. Cl. C08B 3/00

(52) U.S. Cl. 536/58

(57) ABSTRACT

A method of making cellulose ester polymer comprises the steps of: pre-treating a cellulose source; esterifying the pretreated cellulose source to form a cellulose ester; and optionally hydrolyzing the cellulose ester. The pretreatment step further comprises: mixing, in a first stage, the cellulose source with a first solution of a weak acid and water, whereby the cellulose source being suspended in the first solution; de-liquefying the first stage suspension; mixing, in a second stage, the de-liquefied mass with a second solution of weak acid and water, whereby the mass being suspended in the second solution; and de-liquefying the second stage suspension.

### RELATED APPLICATION

The instant application claims the benefit of co-pending U.S. Provisional Patent Application Ser. No. 60/845,664 filed Sep. 19, 2006.

### BACKGROUND OF THE INVENTION

The production of cellulose esters is disclosed in, for example, Kirk-Othmer, Encyclopedia of Chemical Technology, 3^{rd} Edition, vol. 5, pages 100-105 (1979).

Historically, the commercial production of cellulose esters, particularly cellulose acetate (i.e., acetone soluble cellulose acetate), started with high grade cellulose pulps, commonly referred to as ‘acetate grade’ pulps. These ‘acetate grade’ pulps typically have >95% α-cellulose and about 1-3% hemi-cellulose. These pulps, however, are increasing in price, and alternate sources of pulps are being investigated as starting materials for the production process.

Lower grade pulps are known. They include: ‘viscose grade’ pulps (88-95% α-cellulose and about 5-12% hemi-cellulose) and ‘paper/fluff grade’ pulps (about 80-88% α-cellulose and about 12-20% hemi-cellulose). These lower grade pulps can be used to make cellulose esters, but the ester quality is not the same as that made from ‘acetate grade’ pulps. Consequently, additional treatment of the ester made from the lesser grade pulps is required to bring it into line with the ester made from acetate grade pulps. These additional treatments increase the ester production cost.

Accordingly, there is a need for a process to make cellulose esters from lower grade pulps in which the added expense for processing is better balanced with the lower cost raw materials.

Various pretreatment processes are known. For example, two step pre-treatment processes are mentioned in U.S. Pat. Nos. 1,916,273; 2,140,639; 2,478,425; 2,603,634; 2,603,636; 2,603,638; and 2,838,488. In U.S. Pat. Nos. 2,603,634; 2,603,636; and 2,603,638, the pre-treatment process generally comprises: conditioning the cellulose to bring its water content to 2-10 parts by weight/100 parts of cellulose; adding 20-100 parts of a lower aliphatic acid/100 parts of cellulose preferably with 3-20 parts water/100 parts cellulose to the conditioned cellulose; then further adding 35-300 parts lower aliphatic acid and 3-15 parts esterification catalyst/100 parts of cellulose to the conditioned cellulose. The pre-treated cellulose is thereafter esterified.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of a process for making a cellulose ester.

FIG. 2 is a schematic illustration of one embodiment of the pre-treatment process discussed herein.

### SUMMARY OF THE INVENTION

A method of making cellulose ester polymer comprises the steps of: pre-treating a cellulose source; esterifying the pretreated cellulose source to form a cellulose ester; and optionally hydrolyzing the cellulose ester. The pretreatment step further comprises: mixing, in a first stage, the cellulose source with a first solution of a weak acid and water, whereby the cellulose source being suspended in the first solution; de-liquefying the first stage suspension; mixing, in a second stage, the de-liquefied mass with a second solution of weak acid and water, whereby the mass being suspended in the second solution; and de-liquefying the second stage suspension.

### DESCRIPTION OF THE INVENTION

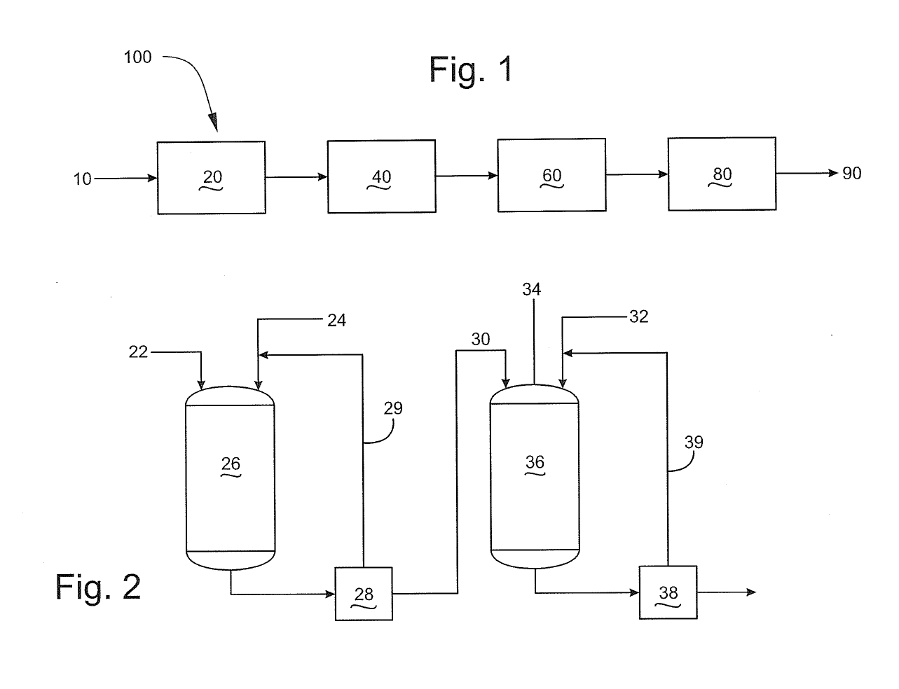

Referring to the drawings wherein like numerals indicate like elements, there is shown in FIG. 1, a schematic illustration of a process 100 for making a cellulose ester. The process 100 includes pre-treatment step 20 and esterification step 40, and optional hydrolyzing step 60 and post-treatment step 80, for converting raw materials 10 into cellulose ester polymer 90. Each of the foregoing shall be discussed in greater detail below.

This process may be used to make any cellulose ester. Cellulose esters include, but are not limited to: cellulose triacetate, cellulose diacetate (e.g., degree of substitution (DS) in the range of 2-3, and commonly known as cellulose acetate), cellulose acetates with DS<2, cellulose formates, cellulose propionates, cellulose butyrates, cellulose acetate propionates, cellulose acetate butyrates, and the like. While the instant process may be used to make any cellulose ester, to simply the following discussion of the invention, the process shall be explained with regard to one embodiment, i.e., the process for making cellulose acetate.

Raw materials 10 refer to the cellulose source used in the process 100. The cellulose source may include any grade wood pulp or cotton linter or regenerated cellulose or combinations thereof. Such wood pulps include: acetate grade pulp (>95% α-cellulose and about 1-3% hemi-cellulose); viscose grade pulp (88-95% α-cellulose and about 5-12% hemi-cellulose); and paper/fluff grade pulp (about 80-88% a-cellulose and about 12-20% hemi-cellulose). Those of ordinary skill will understand that other grades of pulp, i.e., those between the ones mentioned above, may also exist and are included herein. While, any grade of pulp may be used in the instant process, most embodiments may use the non-acetate grade pulps, e.g., pulp grades below the acetate grade pulps, such as viscose grade pulp and paper/fluff grade pulp. Additionally, the pulp may be sourced from hardwood, softwood, or a combination thereof. The pulp may be in any starting form including: sheets, rolls, bales, shreds, chips, or fluff. Pulp, in one embodiment, may be used with only minor physical change to its starting form. In another embodiment, the pulp is reduced to a size that may be readily wetted before it is introduced into the process. The degree of size reduction may be a function of the equipment employed and is well within the ordinary skill of the art.

Pre-treatment step 20 is where the pulp, typically reduced in size, is prepared for subsequent reaction to form the cellulose ester polymer 90, see FIG. 2. In general, the pre-treatment step 20 may comprise a first wetting step 26, followed by de-liquefying 28, then a second wetting step 36, followed by de-liquefying 38. Each of these steps will be discussed in greater detail below.

Pulp 22 is wetted, in a first step 26, with a first solution 24 of water and weak acid. The consistency of the suspension of the pulp and water/weak acid solution may be in the range of 1-18 wt % pulp based on the total weight of the suspension, and in one embodiment, the consistency may be in the range of 2-4 wt %. The weak acid may be in excess of the water. In one embodiment, the solution may comprise 80-95 wt % weak acid and 5-20 wt % water, and in another, the water may comprise 5-10 wt % of the weak acid/water solution. In one embodiment, the weak acid may be a carboxylic acid. Carboxylic acids may be selected from the group of formic acid, acetic acid, propionic acid, butyric acid, and combinations thereof. In another embodiment, the weak acid may be acetic acid. The pulp may be held in this suspension for a period of time ranging from 5-240 minutes, and in one embodiment, the time may range form 5-90 minutes. The pulp may be held in this suspension at a temperature in the range of 0-90° C., and in one embodiment, the temperature may be in the range of 10-50° C.

After the first step 26 of the pre-treatment, the suspension is de-liquefied 28. This de-liquefied mass may have a consistency of 20-90 wt % solids, in one embodiment, the de-liquefied mass has a consistency of 20-50 wt % solids. This mass may be de-liquefied in any conventional manner. Such conventional de-liquefying equipment includes: centrifuges, presses, screens, filters, dryers, and the like. In one embodiment, the mass may be de-liquefied with a centrifuge. The removed liquid may be recycled 29, for example, back to the first step 26. Additionally, the recycled liquid may be withdrawn in a control manner to maintain composition control of the first solution.

The de-liquefied mass 30 is re-wetted, in the second step 36, with a second solution 32 of weak acid and water. In one embodiment, the amount of weak acid in the second solution may be greater than the amount of weak acid in the first solution. The consistency of the suspension of the pulp and water/weak acid solution may be in the range of 1-18 wt% pulp based on the total weight of the suspension, and in one embodiment, the consistency may be in the range of 2-4 wt %. The weak acid may be in excess of the water. In one embodiment, the solution may comprise 80-95 wt % weak acid and 5-20 wt % water, and in another, the water may comprise <1-5 wt % of the weak acid/water solution. In one embodiment, the weak acid may be a carboxylic acid. Carboxylic acids may be selected from the group of formic acid, acetic acid, propionic acid, butyric acid, and combinations thereof. In another embodiment, the weak acid may be acetic acid. The pulp may be held in this suspension for a period of time ranging from 5-240 minutes, and in one embodiment, the time may range form 5-90 minutes. The pulp may be held in this suspension at a temperature in the range of 0-90° C., and in one embodiment, the temperature may be in the range of 10-50° C. optionally, a portion 34 of the strong acid catalyst, discussed in greater detail below with regard to the esterification step, may be added to the second step 36 of the pre-treatment. When the strong acid catalyst from the esterification step is added in the pre-treatment step, the amount of strong acid catalyst added in the esterification step may be proportionally reduced.

After the second step 36 of the pre-treatment, the suspension is de-liquefied 38. This de-liquefied mass may have a consistency of 20-90 wt % solids. In one embodiment, the de-liquefied mass has a consistency of 20-50 wt % solids. This mass may be de-liquefied in any conventional manner. Such conventional de-liquefying equipment includes: centrifuges, presses, screens, filters, dryers, and the like. In one embodiment, the mass may be de-liquefied with a centrifuge. The removed liquid may be recycled 39, for example, back to the first step 26 or second step 36 or both. Additionally, the recycled liquid may be withdrawn in a control manner to maintain composition control of the first or second solution, as required.

Esterification step 40 may be conducted in any conventional manner and may be a batch or continuous process. Esterification is the process where hydroxyl groups on the cellulose polymer are replaced with a desired ester moiety. Chemically, in the esterification reaction, the pulp is initially suspended in a weak acid along with a source of the ester moieties (e.g., a suitable anhydride) and the strong acid catalyst. The strong acid catalyst may be selected from the group of sulfuric acid, perchloric acid, substituted sulfuric acids (e.g., methane sulfonic acid), or others that are known to those skilled in the art. The reaction is driven until all (or substantially all) of the hydroxyl groups have been replaced by the ester moieties. When the cellulose ester is cellulose acetate, the hydroxyl groups are replaced with acetate moieties (sourced from, for example, acetic anhydride) and the esterification is referred to acetylation. Esterification may be conducted in the temperature range of 35-100° C. under reduced or atmospheric pressure and using <20 wt % strong acid catalyst (wt % based on bone dry cellulose and including total catalyst added during pre-treatment and esterification). In one embodiment, the strong acid is present at <7 wt %.

Acetylation may be conducted in any manner. In one embodiment, the historical method of preparing cellulose acetate, the strong inorganic acid catalyst, a portion of the acetic acid and all of the acetic anhydride are chilled and then added to an ambient temperature pulp/acetic acid suspension, so that the temperature of the batch may be controlled in the strong exothermic reaction. In another embodiment, high temperature acetylation (HTA) may be used. HTA processes are known and disclosed in U.S. Pat. Nos. 2,923,706; 4,439,605; and EP Publication No. 626,391, each of which is incorporated herein by reference. In general, HTA processes are conducted at temperatures of 50-100° C.

Optional hydrolysis step 60 may be conducted in any conventional manner and may be a batch process or a continuous process. Hydrolysis (or ripening) is where excess ester moieties are removed from the cellulose chain and replaced with hydroxyl groups. For example, when the cellulose polymer is acetylated, the resulting product is referred to as cellulose triacetate (DS=3). Cellulose triacetate polymer has many uses, but because it is not readily dissolved in acetone, it cannot be spun into certain commercial filaments. To make it acetone-soluble and to achieve other desirable properties, some of the acetate moieties must be replaced with hydroxyl groups. So, hydrolysis is conducted until the cellulose triacetate becomes soluble, for example, in acetone (DS<3 or 2.3-2.6).

Hydrolysis step 60 may be conducted in any conventional manner. In one embodiment, hydrolysis may be conducted at 50-100° C. in the presence of the strong acid catalyst. In another embodiment, high temperature ripening (HTR) may be used. HTR processes are known and disclosed in U.S. Pat. Nos. 3,767,642; 4,439,605; and EP Publication No. 626,391, each of which is incorporated herein by reference. In general, HTR processes are conducted, after partial or complete neutralization of the strong acid catalyst, at temperatures of 100-170° C.

After hydrolysis, the polymer mass may be cooled, if necessary to a temperature in the range of 70-110° C. In one embodiment, cooling is accomplished by flash cooling under reduced or atmospheric pressure. For example see: U.S. Pat. No. 4,504,355, incorporated herein by reference.

Optional post-treatment step 80 may be conducted in any conventional manner and may be a batch process or a continuous process. In general, post-treatment step 80 may include any one or combination of the following conventional steps: precipitating the cellulose ester from the reaction mass; washing the precipitated cellulose ester; drying the washed cellulose ester; and bleaching the dried cellulose ester. Each of these steps is conventional. Bleaching may be accomplished by contacting the precipitated cellulose ester polymer with hydrogen peroxide or other oxidants. The amount of bleaching agent and the point(s) of exposure may be changed as needed to achieve the desired results.

The foregoing invention is further illustrated in the following non-limiting examples. The quality of cellulose ester (i.e., cellulose acetate for these examples) is indicated by its plugging value and the solution delta haze.

The plugging value is obtained by measuring the amount of cellulose acetate in the form of polymer dissolved in an acetone/water solvent (e.g., 9 wt % polymer in a 95 wt % acetone/5 wt % water solvent) at 200 psig that will pass through a commercial fabric filter media (20 cfm/ft² Frazier permeability) before the media is blocked by insoluble or partially soluble materials. Filter blocking materials are undesirable and are indicated by low plugging value (values above 20-30 g/cm² are preferred).

The solution haze is based on measurements (e.g., 3% w/v polymer dissolved in a 95 wt % acetone/5 wt % water solvent) before and after the solution is centrifuged at 2500 rpm for a period of 10 minutes. Insoluble and partially soluble materials are undesirable and contribute to solution haze. Delta haze is the difference between the two haze measurements (measured for example by light transmission through an optical cell). In general, delta haze numbers will correlate with the ester plugging value (delta haze numbers below 4-5 are preferred).

### EXAMPLES

| | | | Slurry | Stage 1 | Stage 2 | Slurry | Slurry Time, | | Solution |
|---|---|---|---|---|---|---|---|---|---|
| | Process | | Consistency | Liquid | Liquid | Temperature | Each Stage | Plugging | Delta |
| Example¹ | Description | Pulp | (wt % solids) | (wt % water) | (wt % water) | (Deg C.) | (minutes) | Value | Haze |
| A | Standard² | Hardwood | N/A | N/A | N/A | N/A | N/A | 65 | 2.8 |
| | | 98% R-10 | | | | | | | |
| B | Standard² | Hardwood | N/A | N/A | N/A | N/A | N/A | 45 | 4.1 |
| | | 94% R-10 | | | | | | | |
| B1 | Two-stage slurry³ | Hardwood | 3 | 10 | <1 | ambient | 45–60 | 107 | 2.5 |
| | | 94% R-10 | | | | | | | |
| C | Standard² | Hardwood | N/A | N/A | N/A | N/A | N/A | <10 | >14 |
| | | 90% R-10 | | | | | | | |
| C1 | One-stage slurry⁴ | Hardwood | 3 | 5 | N/A | ambient | 45–60 | 14 | 8.2 |
| | | 90% R-10 | | | | | | | |
| C2 | Two-stage slurry⁵ | Hardwood | 3 | 10 | 5 | ambient | 45–60 | 32 | 4.6 |
| | | 90% R-10 | | | | | | | |
| C3 | Two-stage slurry⁶ | Hardwood | 3 | 10 | 5 | ambient | 45–60 | 88 | 3.0 |
| | | 90% R-10 | | | | | | | |
| D | Standard² | Softwood | N/A | N/A | N/A | N/A | N/A | 33 | 7.5 |
| | | 94% R-10 | | | | | | | |
| D1 | Two-stage slurry³ | Softwood | 3 | 10 | <1 | ambient | 45–60 | 71 | 3.4 |
| | | 94% R-10 | | | | | | | |
| E | Standard² | Softwood | N/A | N/A | N/A | N/A | N/A | 55 | 3.9 |
| | | 92% R-10 | | | | | | | |
| E1 | Two-stage slurry³ | Softwood | 3 | 10 | <1 | ambient | 45–60 | 113 | 3.1 |
| | | 92% R-10 | | | | | | | |

Notes:
¹All examples are based on the production of cellulose acetate polymer. Typical degree of substitution is 2.41–2.48. Typical intrinsic viscosity is 1.50–1.75 dl/g.
²Acetic acid pretreat (0.4 parts to 1.0 parts dry cellulose) with hydrolysis at 80–90 C.
³Pretreat mixtures of acetic acid and water with hydrolysis at 80–90 C.
⁴Pretreat mixtures of acetic acid and water with hydrolysis at 140–150 C.
⁵Pretreat mixtures of acetic acid and water with hydrolysis at 140–150 C.
⁶Same as note four except with about one-half of the esterification catalyst added to the second-stage slurry mixture.

The present invention may be embodied in other forms without departing from the spirit and the essential attributes thereof, and, accordingly, reference should be made to the appended claims, rather than to the foregoing specification, as indicated the scope of the invention.

We claim:

1. A method of making cellulose ester polymer comprising the steps of:
pre-treating a cellulose source by
mixing, in a first stage, the cellulose source with a first solution of a weak acid and water, whereby the cellulose source being suspended in the first solution,
de-liquefying the first stage suspension, mixing, in a second stage, the de-liquefied mass with a second solution of weak acid and water, whereby the mass being suspended in the second solution, and
de-liquefying the second stage suspension; and
esterifying the pretreated cellulose source to form a cellulose ester.

2. The method of claim 1 further comprising the step of hydrolyzing the cellulose ester.

3. The method of claim 1 wherein the first solution comprising the weak acid being in excess of the water.

4. The method of claim 1 wherein the second solution containing more weak acid than the first solution.

5. The method of claim 1 wherein the cellulose source being selected from the group consisting of: acetate grade pulp, viscose grade pulp, paper/fluff grade pulp, cotton linter, and combinations thereof.

6. The method of claim 1 wherein the first mentioned de-liquefying being accomplished via centrifuging.

7. The method of claim 1 wherein the second mentioned de-liquefying being accomplished via centrifuging.

8. The method of claim 1 wherein the second solution further comprises a strong acid.

9. The method of claim 8 wherein the strong acid being sulfuric acid.

10. The method of claim 1 wherein the first stage suspension comprising 1-18 wt % solids.

11. The method of claim 1 wherein the second stage suspension comprising 1-18 wt % solids.

12. The method of claim 1 wherein the second stage suspension being de-liquefied to a mass of greater than 20 wt % solids.

13. The method of claim 5 wherein the cellulose source being in a form selected from the group consisting of sheet, roll, bale, shred, chip, fluff, cotton linter, and combinations thereof.

14. The method of claim 1 further comprising recycling the liquid from the first de-liquefying step back to the first stage.

15. The method of claim 1 further comprising recycling the liquid from the second de-liquefying step back to either the first stage, or the second stage, or both.

16. The method of claim 14 further comprising a controlled withdrawal of recycled liquid for the purpose of composition control.

17. The method of claim 15 further comprising a controlled withdrawal of recycled liquid for the purpose of composition control.

18. The method of claim 1 wherein esterifying being conducted at a temperature in the range of 35° C.-100° C. under reduced or atmospheric pressure.

19. The method of claim 2 wherein hydrolyzing being conducted at a temperature in the range of 50° C.-170° C.

20. The method of claim 2 further comprising the step of cooling the cellulose ester dope to a temperature in the range of 70° C.-110° C.

21. The method of claim 20 wherein cooling being flash cooling the cellulose ester dope under reduced or atmospheric pressure.

22. The method of claim 1 further comprising the step of finishing the cellulose ester dope.

23. The method of claim 22 wherein finishing the cellulose ester dope comprising the steps of:
precipitating the cellulose ester polymer from the dope,
washing the cellulose ester polymer, and
drying the cellulose ester polymer.

24. The method of claim 22 further comprising the step of:
bleaching the cellulose ester polymer.

25. The method of claim 24 wherein bleaching comprising the step of contacting the cellulose ester polymer with hydrogen peroxide or other oxidants.

26. The method of claim 1 being continuous.

27. The method of claim 1 being continuous pre-treating with esterification and hydrolysis by batch.

28. A process for pre-treating a cellulose source for the production of cellulose esters comprising the steps of:
mixing, in a first stage, the cellulose source with a first solution of a weak acid and water, whereby the cellulose source being suspended in the first solution, the cellulose source being selected from the group consisting of: acetate grade pulp, viscose grade pulp, paper/fluff grade pulp, cotton linter, and combinations thereof;
de-liquefying the first stage suspension;
mixing, in a second stage, the de-liquefied mass with a second solution of weak acid and water, whereby the mass being suspended in the second solution; and
de-liquefying the second stage suspension.

29. The method of claim 28 wherein the first solution comprising the weak acid being in excess of the water.

30. The method of claim 28 wherein the second solution containing more weak acid than the first solution.

31. The method of claim 28 wherein the first mentioned de-liquefying being accomplished via centrifuging.

32. The method of claim 28 wherein the second mentioned de-liquefying being accomplished via centrifuging.

33. The method of claim 28 wherein the second solution further comprises a strong acid.

34. The method of claim 33 wherein the strong acid being sulfuric acid.

35. The method of claim 28 wherein the first stage mixture comprising 1-18 wt % solids.

36. The method of claim 28 wherein the second stage mixture comprising 1-18 wt % solids.

37. The method of claim 28 wherein the second stage mixture being de-liquefied to a mass of greater than 20 wt % solids.

38. The method of claim 28 wherein the cellulose source being in a form selected from the group consisting of sheet, roll, bale, shred, chip, fluff, cotton linter, and combinations thereof.

39. The method of claim 28 further comprising recycling the liquid from the first de-liquefying step back to the first stage.

40. The method of claim 28 further comprising recycling the liquid from the second de-liquefying step back to either the first stage, or the second stage, or both.

41. The method of claim 39 further comprising a controlled withdrawal of recycled liquid for the purpose of composition control.

42. The method of claim 40 further comprising a controlled withdrawal of recycled liquid for the purpose of composition control.
